(19) United States
(12) Patent Application Publication
(10) Pub. No.: US 2018/0084469 A1
(43) Pub. Date: Mar. 22, 2018

(54) TECHNIQUES AND APPARATUSES FOR REDUCING DELAY WHEN OBTAINING SERVICE

(71) Applicant: QUALCOMM Incorporated, San Diego, CA (US)

(72) Inventors: Vishnu Namboodiri Karakkad NAMBOODIRI, Hyderabad (IN); Mukesh KUMAR, Hyderabad (IN); Suresh SANKA, Hyderabad (IN)

(21) Appl. No.: 15/273,241

(22) Filed: Sep. 22, 2016

(51) Int. Cl. H04W 36/08

(52) U.S. Cl. CPC H04W 36/08; H04W 36/30

(57) ABSTRACT

Certain aspects of the present disclosure generally relate to wireless communications. In some aspects, a wireless communication device may determine, concurrent with reading of one or more system information blocks (SIBs) of a first frequency, acquisition information for a second frequency. In some aspects, the wireless communication device may perform a reading of one or more SIBs associated with the second frequency based on determining the acquisition information for the second frequency and to cause the wireless communication device to camp on a cell associated with the second frequency. Numerous other aspects are provided.

### FIELD OF THE DISCLOSURE

Aspects of the present disclosure generally relate to wireless communications, and more particularly to techniques and apparatuses for reducing delay when obtaining service, for example, when camping on a cell, such as, for example, techniques and apparatuses for determining, concurrent with reading one or more system information blocks (SIBs) of a first frequency, acquisition information for a second frequency.

### BACKGROUND

Wireless communication systems are widely deployed to provide various telecommunication services, such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, a national, a regional, and even a global level. An example of a telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, using new spectrum, and integrating with other open standards using OFDMA on the downlink (DL), SC-FDMA on the uplink (UL), and multiple-input multiple-output (MIMO) antenna technology. Camping on a cell is a time consuming process. Methods and apparatuses for reducing delay when obtaining service are desired.

### SUMMARY

In some aspects, a method of wireless communication may include determining, by a wireless communication device and concurrent with a reading of one or more system information blocks (SIBs) of a first frequency, acquisition information for a second frequency. The method may include performing, by the wireless communication device, a reading of one or more SIBs associated with the second frequency based on determining the acquisition information for the second frequency and to cause the wireless communication device to camp on a cell associated with the second frequency.

In some aspects, a non-transitory computer-readable medium may store one or more instructions for wireless communication. The one or more instructions may include one or more instructions that, when executed by one or more processors of a wireless communication device, cause the one or more processors to determine, concurrent with a reading of one or more SIBs of a first frequency, acquisition information for a second frequency. The one or more instructions may cause the one or more processors to perform a reading of one or more SIBs associated with the second frequency based on determining the acquisition information for the second frequency and to cause the wireless communication device to camp on a cell associated with the second frequency.

In some aspects, an apparatus for wireless communication may include means for determining, concurrent with a reading of one or more SIBs of a first frequency, acquisition information for a second frequency. The apparatus may include means for performing a reading of one or more SIBs associated with the second frequency based on determining the acquisition information for the second frequency and to cause the wireless communication device to camp on a cell associated with the second frequency.

Aspects generally include a method, wireless communication device, computer program product, non-transitory computer-readable medium (e.g., for storing instructions), and user equipment (UE), as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example deployment in which multiple wireless networks have overlapping coverage, in accordance with various aspects of the present disclosure.

FIG. 2 is a diagram illustrating an example access network in an LTE network architecture, in accordance with various aspects of the present disclosure.

FIG. 3 is a diagram illustrating an example of a downlink frame structure in LTE, in accordance with various aspects of the present disclosure.

FIG. 4 is a diagram illustrating an example of an uplink frame structure in LTE, in accordance with various aspects of the present disclosure.

FIG. 5 is a diagram illustrating an example of a radio protocol architecture for a user plane and a control plane in LTE, in accordance with various aspects of the present disclosure.

FIG. 6 is a diagram illustrating example components of an evolved Node B and a user equipment in an access network, in accordance with various aspects of the present disclosure.

FIGS. 7A and 7B are diagrams of an overview of an example aspect described herein, in accordance with various aspects of the present disclosure.

FIG. 8 is a diagram illustrating an example process performed, for example, by a wireless communication device, in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for providing a thorough understanding of the various concepts. However, it will be apparent to those skilled in the art that these concepts may be practiced without these specific details.

The techniques described herein may be used for one or more of various wireless communication networks such as code division multiple access (CDMA) networks, time division multiple access (TDMA) networks, frequency division multiple access (FDMA) networks, orthogonal FDMA (OFDMA) networks, single carrier FDMA (SC-FDMA) networks, or other types of networks. A CDMA network may implement a radio access technology (RAT) such as universal terrestrial radio access (UTRA), CDMA2000, and/or the like. UTRA may include wideband CDMA (WCDMA) and/or other variants of CDMA. CDMA2000 may include Interim Standard (IS)-2000, IS-95 and IS-856 standards. IS-2000 may also be referred to as 1× radio transmission technology (1×RTT), CDMA2000 1×, and/or the like. A TDMA network may implement a RAT such as global system for mobile communications (GSM), enhanced data rates for GSM evolution (EDGE), or GSM/EDGE radio access network (GERAN). An OFDMA network may implement a RAT such as evolved UTRA (E-UTRA), ultra mobile broadband (UMB), Institute of Electrical and Electronics Engineers (IEEE) 802.11 (Wi-Fi), IEEE 802.16 (WiMAX), IEEE 802.20, Flash-OFDM, and/or the like. UTRA and E-UTRA may be part of the universal mobile telecommunication system (UMTS). 3GPP long-term evolution (LTE) and LTE-Advanced (LTE-A) are example releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and RATs mentioned above as well as other wireless networks and RATs.

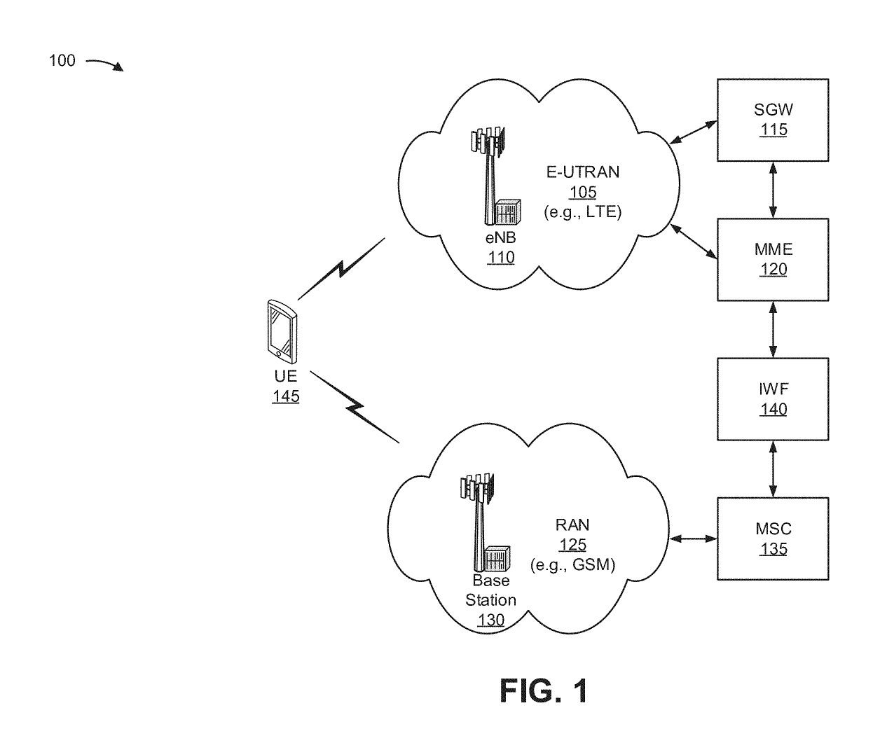

FIG. 1 is a diagram illustrating an example deployment 100 in which multiple wireless networks have overlapping coverage, in accordance with various aspects of the present disclosure. As shown, example deployment 100 may include a first radio access network (RAN), such as an evolved universal terrestrial radio access network (E-UTRAN) 105, which may include one or more evolved Node Bs (eNBs) 110, and which may communicate with other devices or networks via a serving gateway (SGW) 115 and/or a mobility management entity (MME) 120. As further shown, example deployment 100 may include a second RAN 125, which may include one or more base stations 130, and which may communicate with other devices or networks via a mobile switching center (MSC) 135 and/or an inter-working function (IWF) 140. As further shown, example deployment 100 may include one or more user equipment (UEs) 145 capable of communicating via E-UTRAN 105 and/or RAN 125.

E-UTRAN 105 may support, for example, LTE or another type of RAT. E-UTRAN 105 may include eNBs 110 and other network entities that can support wireless communication for UEs 145. Each eNB 110 may provide communication coverage for a particular geographic area. The term “cell” may refer to a coverage area of eNB 110 and/or an eNB subsystem serving the coverage area.

SGW 115 may communicate with E-UTRAN 105 and may perform various functions, such as packet routing and forwarding, mobility anchoring, packet buffering, initiation of network-triggered services, and/or the like. MME 120 may communicate with E-UTRAN 105 and SGW 115 and may perform various functions, such as mobility management, bearer management, distribution of paging messages, security control, authentication, gateway selection, and/or the like, for UEs 145 located within a geographic region served by MME 120 of E-UTRAN 105. The network entities in LTE are described in 3GPP TS 36.300, entitled “Evolved Universal Terrestrial Radio Access (E-UTRA) and Evolved Universal Terrestrial Radio Access Network (E-UTRAN); Overall description,” which is publicly available.

RAN 125 may support, for example, GSM or another type of RAT. RAN 125 may include base stations 130 and other network entities that can support wireless communication for UEs 145. MSC 135 may communicate with RAN 125 and may perform various functions, such as voice services, routing for circuit-switched calls, and mobility management for UEs 145 located within a geographic region served by MSC 135 of RAN 125. In some aspects, IWF 140 may facilitate communication between MME 120 and MSC 135 (e.g., when E-UTRAN 105 and RAN 125 use different RATs). Additionally, or alternatively, MME 120 may communicate directly with an MME that interfaces with RAN 125, for example, without IWF 140 (e.g., when E-UTRAN 105 and RAN 125 use a common RAT). In some aspects, E-UTRAN 105 and RAN 125 may use a common frequency and/or a common RAT to communicate with UE 145. In some aspects, E-UTRAN 105 and RAN 125 may use different frequencies and/or different RATs to communicate with UEs 145.

In general, any number of wireless networks may be deployed in a given geographic area. Each wireless network may support a particular RAT and may operate on one or more frequencies. A RAT may also be referred to as a radio technology, an air interface, and/or the like. A frequency or frequency ranges may also be referred to as a carrier, a frequency channel, and/or the like. Each frequency or frequency range may support a single RAT in a given geographic area in order to avoid interference between wireless networks of different RATs.

UE 145 may be stationary or mobile and may also be referred to as a mobile station, a terminal, an access terminal, a wireless communication device, a subscriber unit, a station, and/or the like. UE 145 may be a cellular phone, a personal digital assistant (PDA), a wireless modem, a wireless communication device, a handheld device, a laptop computer, a cordless phone, a wireless local loop (WLL) station, and/or the like.

Upon power up, UE 145 may search for wireless networks from which UE 145 can receive communication services. If UE 145 detects more than one wireless network, then a wireless network with the highest priority may be selected to serve UE 145 and may be referred to as the serving network. UE 145 may perform registration with the serving network, if necessary. UE 145 may then operate in a connected mode to actively communicate with the serving network. Alternatively, UE 145 may operate in an idle mode and camp on the serving network if active communication is not required by UE 145.

UE 145 may operate in the idle mode as follows. UE 145 may identify all frequencies/RATs on which it is able to find a “suitable” cell in a normal scenario or an “acceptable” cell in an emergency scenario, where “suitable” and “acceptable” are specified in the LTE standards. UE 145 may then camp on the frequency/RAT (e.g., or cell associated therewith) with the highest priority among all identified frequencies/RATs. UE 145 may remain camped on this frequency/RAT until either (i) the frequency/RAT is no longer available at a predetermined threshold or (ii) another frequency/RAT with a higher priority reaches this threshold. In some aspects, UE 145 may receive a neighbor list when operating in the idle mode, such as a neighbor list included in a system information block type 5 (SIB 5) provided by an eNB of a RAT or cell on which UE 145 is camped. Additionally, or alternatively, UE 145 may generate a neighbor list. A neighbor list may include information identifying one or more frequencies, at which one or more RATs may be accessed, priority information associated with the one or more RATs, and/or the like.

A network may provide network connectivity using a set of transmission frequencies. A UE 145 may perform a power scan after, for example, transferring from an out of service (OOS) mode or a sleep mode. The UE 145 may attempt to camp on a first cell associated with a first acquired frequency. For example, the UE 145, may attempt to camp on a cell associated with a first UTRA Absolute Radio Frequency Channel (UARFCN). To camp on the cell associated with the first channel, the UE 145 may perform a reading of one or more system information blocks (SIBs) associated with the first frequency. During the reading of the one or more SIBs associated with the first frequency, the UE 145 may enter an idle mode for a period of time. After the reading of the one or more SIBs associated with the first frequency, the UE 145 may attempt to camp on the cell associated with the first frequency to access the network.

The UE 145 may determine that the first frequency is unavailable or may fail to camp on the cell associated with the first frequency. In this case, the UE 145 may perform a second power scan of a second frequency associated with a second channel. After performing the second power scan of the second frequency, UE 145 may perform a reading of one or more SIBs associated with the second frequency, and may attempt to camp on a cell associated with the second frequency to access the network. However, performing the second power scan of the second frequency after failing to camp on the cell associated with the first frequency may cause an excessive delay in UE 145 camping on a cell associated with the second frequency, registering with the network, and/or obtaining service.

A UE 145 may perform the second power scan of the second frequency concurrent with reading the one or more SIBs associated with the first frequency. For example, rather than entering the idle mode during reading of the one or more SIBs associated with the first frequency, the UE 145 may perform an acquisition procedure including a power scan, for example, of the second frequency and/or one or more other frequencies. The UE 145 may obtain acquisition information regarding the second frequency and/or the one or more other frequencies and may, upon failing to camp on the cell associated with the first frequency, perform (e.g., directly) a reading of one or more SIBs associated with the second frequency and attempt to camp on a cell associated with the second frequency using the acquisition information.

In this way, the techniques and apparatuses, disclosed herein, may reduce an amount of time used to camp on a network (e.g., a cell thereof), thereby reducing a utilization of power resources and/or network resources relative to the UE 145 obtaining acquisition information for the second frequency after a failure to camp on a cell associated with the first frequency. Moreover, the UE 145 may provide improved performance and user experience based on camping on the network and/or obtaining service in a reduced amount of time.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

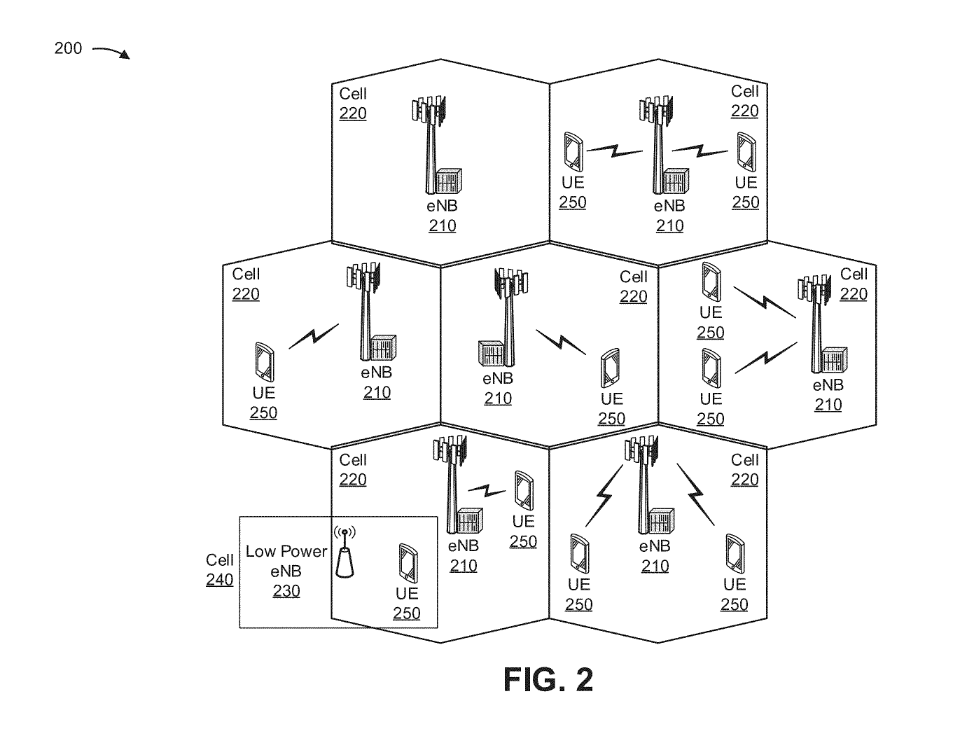

FIG. 2 is a diagram illustrating an example access network 200 in an LTE network architecture, in accordance with various aspects of the present disclosure. As shown, access network 200 may include one or more eNBs 210 that serve a corresponding set of cellular regions (cells) 220, one or more low power eNBs 230 that serve a corresponding set of cells 240, and a set of UEs 250.

Each eNB 210 may be assigned to a respective cell 220 and may be configured to provide an access point to a RAN. For example, eNB 110, 210 may provide an access point for UE 145, 250 to E-UTRAN 105 (e.g., eNB 210 may correspond to eNB 110, shown in FIG. 1) or may provide an access point for UE 145, 250 to RAN 125 (e.g., eNB 210 may correspond to base station 130, shown in FIG. 1). UE 145, 250 may correspond to UE 145, shown in FIG. 1. FIG. 2 does not illustrate a centralized controller for example access network 200, but access network 200 may use a centralized controller in some aspects. The eNBs 210 may perform radio related functions including radio bearer control, admission control, mobility control, scheduling, security, and network connectivity (e.g., to SGW 115).

As shown in FIG. 2, one or more low power eNBs 230 may serve respective cells 240, which may overlap with one or more cells 220 served by eNBs 210. The eNBs 230 may correspond to eNB 110 associated with E-UTRAN 105 and/or base station 130 associated with RAN 125, shown in FIG. 1. A low power eNB 230 may be referred to as a remote radio head (RRH). The low power eNB 230 may include a femto cell eNB (e.g., home eNB (HeNB)), a pico cell eNB, a micro cell eNB, and/or the like.

UE 145, 250 may attempt to connect to one or more eNBs 110, 210, 230. For example, UE 145, 250 may read one or more SIBs provided by eNB 110, 210, 230 for a first frequency and may, concurrently, perform an acquisition procedure, which may include a power scan, of one or more second frequencies to obtain acquisition information for the one or more second frequencies provided by eNB 110, 210, 230. After a failure to camp on a cell associated with the first frequency, UE 145, 250 may utilize the acquisition information, such as a set of scrambling codes (e.g., a primary synchronization signal (PSS) and/or a secondary synchronization signal (SSS)) associated with one or more second frequencies, to perform a reading of one or more SIBs provided by eNB 110, 210, 230 and associated with the one or more second frequencies.

In this case, UE 145, 250 may camp on a cell associated with one of the one or more second frequencies to obtain access to a network. For example, UE 145, 250 may camp on a particular second frequency provided by and/or associated with eNB 110, 210, 230, and may utilize network connectivity provided by eNB 110, 210, 230. In this way, UE 145, 250 may reduce an amount of time to camp on the network relative to obtaining the acquisition information for the one or more second frequencies after failing to camp on the first frequency.

A modulation and multiple access scheme employed by access network 200 may vary depending on the particular telecommunications standard being deployed. In LTE applications, OFDM is used on the downlink (DL) and SC-FDMA is used on the uplink (UL) to support both frequency division duplexing (FDD) and time division duplexing (TDD). The various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. As another example, these concepts may also be extended to UTRA employing WCDMA and other variants of CDMA (e.g., such as TD-SCDMA, GSM employing TDMA, E-UTRA, and/or the like), UMB, IEEE 802.11 (Wi-Fi), IEEE 802.16 (WiMAX), IEEE 802.20, Flash-OFDM employing OFDMA, and/or the like. UTRA, E-UTRA, UMTS, LTE, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 110, 210, 230 may have multiple antennas supporting MIMO technology. The use of MIMO technology enables eNBs 110, 210, 230 to exploit the spatial domain to support spatial multiplexing, beamforming, and transmit diversity. Spatial multiplexing may be used to transmit different streams of data simultaneously on the same frequency. The data streams may be transmitted to a single UE 145, 250 to increase the data rate or to multiple UEs 250 to increase the overall system capacity. This may be achieved by spatially precoding each data stream (e.g., applying a scaling of an amplitude and a phase) and then transmitting each spatially precoded stream through multiple transmit antennas on the DL. The spatially precoded data streams arrive at the UE(s) 250 with different spatial signatures, which enables each of the UE(s) 250 to recover the one or more data streams destined for that UE 145, 250. On the UL, each UE 145, 250 transmits a spatially precoded data stream, which enables eNBs 110, 210, 230 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR), which is sometimes referred to as a PAR value.

The number and arrangement of devices and cells shown in FIG. 2 are provided as an example. In practice, there may be additional devices and/or cells, fewer devices and/or cells, different devices and/or cells, or differently arranged devices and/or cells than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

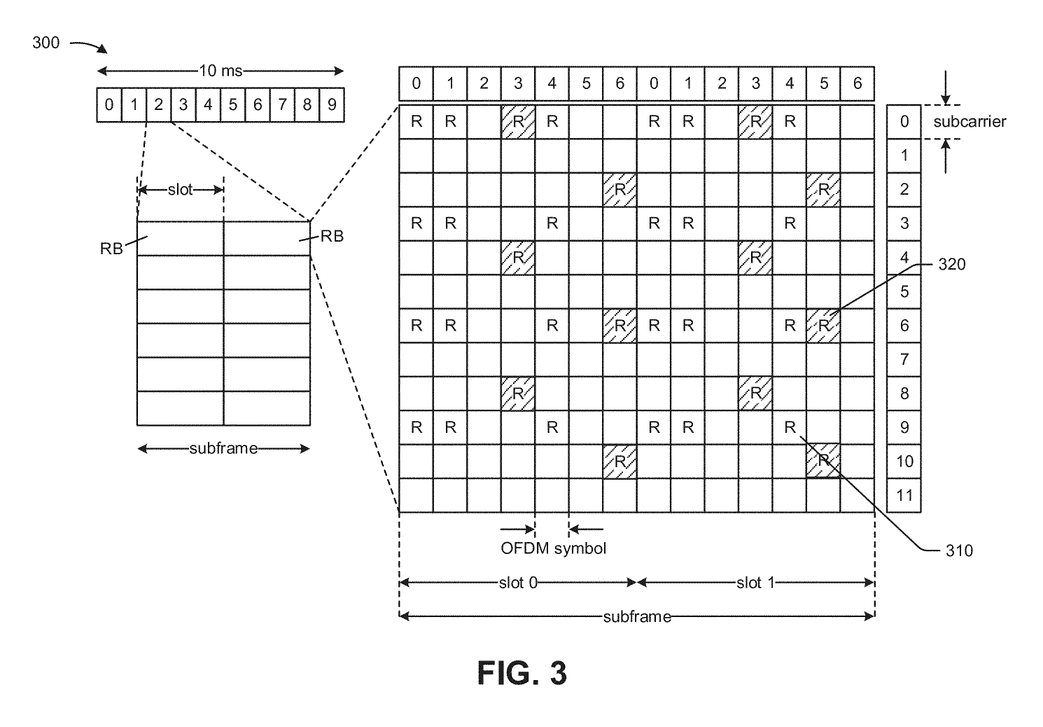

FIG. 3 is a diagram illustrating an example 300 of a downlink (DL) frame structure in LTE, in accordance with various aspects of the present disclosure. A frame (e.g., of 10 ms) may be divided into 10 equally sized sub-frames with indices of 0 through 9. Each sub-frame may include two consecutive time slots. A resource grid may be used to represent two time slots, each time slot including a resource block (RB). The resource grid is divided into multiple resource elements. In LTE, a resource block includes 12 consecutive subcarriers in the frequency domain and, for a normal cyclic prefix in each OFDM symbol, 7 consecutive OFDM symbols in the time domain, or 84 resource elements. For an extended cyclic prefix, a resource block includes 6 consecutive OFDM symbols in the time domain and has 72 resource elements. Some of the resource elements, as indicated as R 310 and R 320, include DL reference signals (DL-RS). The DL-RS include Cell-specific RS (CRS) (also sometimes called common RS) 310 and UE-specific RS (UE-RS) 320. UE-RS 320 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

UE 145, 250 may receive information from eNB 110, 210, 230 via a DL frame, as described herein. For example, UE 145, 250 may receive, via the DL frame, acquisition information for a first frequency. Based on receiving the acquisition information for the first frequency, UE 145, 250 may utilize the acquisition information to perform a first reading of one or more SIBs of the first frequency. In this case, UE 145, 250 may perform, concurrently with and/or during the first reading of the one or more SIBs, a power scan of and/or acquisition procedure for a second frequency to obtain acquisition information for the second frequency via another DL frame. UE 145, 250 may use the acquisition information for the second frequency to perform a reading of the one or more SIBs of the second frequency after, for example, failing to camp on a cell associated with the first frequency. In this way, UE 145, 250 reduces an amount of time used to camp on a network relative to obtaining acquisition information for the second frequency after completing the reading of the one or more SIBs for the first frequency.

As indicated above, FIG. 3 is provided as an example. Other examples are possible and may differ from what was described above in connection with FIG. 3.

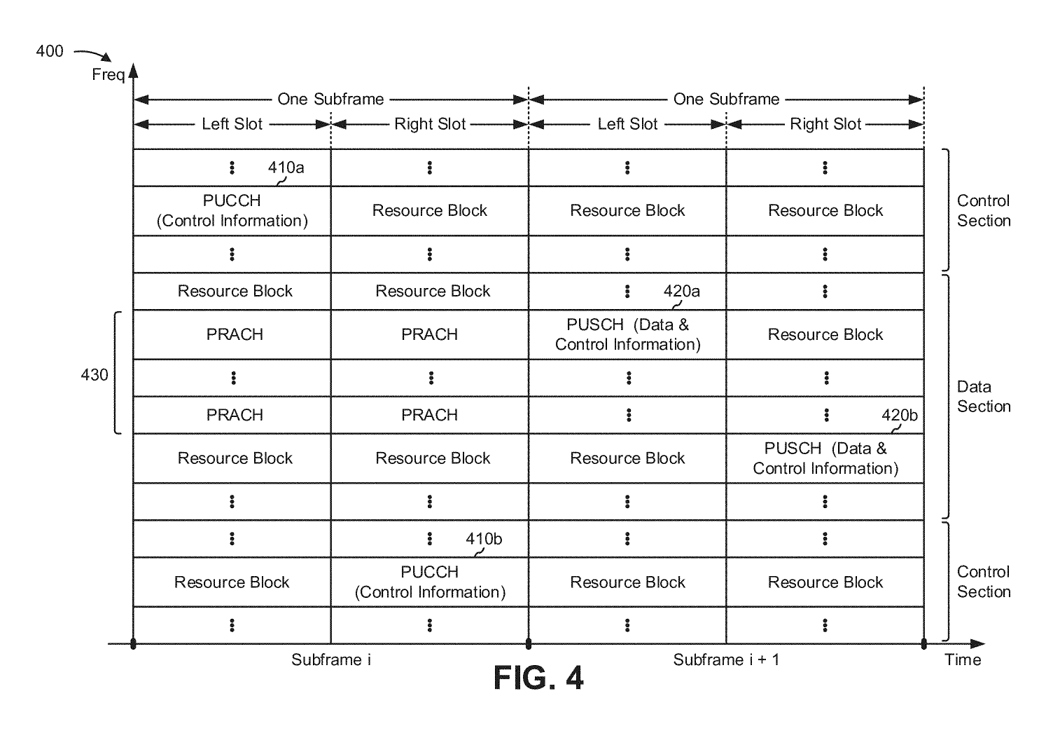

FIG. 4 is a diagram illustrating an example 400 of an uplink (UL) frame structure in LTE, in accordance with various aspects of the present disclosure. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequencies.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (e.g., of 1 ms) or in a sequence of few contiguous subframes and a UE can make only a single PRACH attempt per frame (e.g., of 10 ms).

UE 145, 250 may transmit one or more signals via a UL frame, as described herein. For example, UE 145, 250 may transmit, via a UL frame, information associated with obtaining, concurrent with a reading of one or more SIBs of a first frequency, acquisition information for a second frequency. UE 145, 250 may perform a reading of one or more SIBs of the second frequency based on obtaining the acquisition information for the second frequency. In this case, UE 145, 250 may transmit information, via another UL frame, to attempt to camp on a network (e.g., a cell thereof) using the second frequency, and may camp on the network as a result of the attempt. In this way, UE 145, 250 reduces an amount of time that UE 145, 250 uses to camp on a network relative to scanning the second frequency and obtaining the acquisition information for the second frequency after failing to camp on the cell associated with the first frequency to access the network. Moreover, based on reducing an amount of time used to camp on the network, UE 145, 250 improves utilization of energy resources, network performance, and/or user experience relative to another technique with a greater amount of time used to camp on the network.

As indicated above, FIG. 4 is provided as an example. Other examples are possible and may differ from what was described above in connection with FIG. 4.

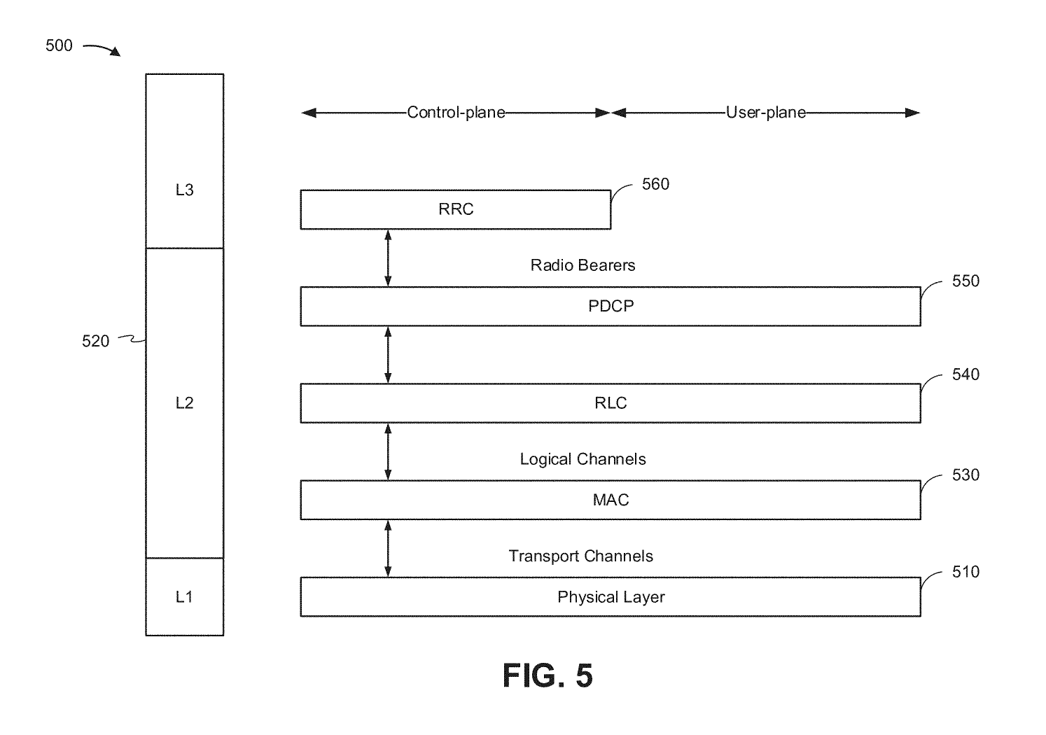

FIG. 5 is a diagram illustrating an example 500 of a radio protocol architecture for a user plane and a control plane in LTE, in accordance with various aspects of the present disclosure. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 510. Layer 2 (L2 layer) 520 is above the physical layer 510 and is responsible for the link between the UE and eNB over the physical layer 510.

In the user plane, the L2 layer 520, for example, includes a media access control (MAC) sublayer 530, a radio link control (RLC) sublayer 540, and/or a packet data convergence protocol (PDCP) 550 sublayer, which are terminated at the eNB on the network side. Although not shown, the UE may have several upper layers above the L2 layer 520 including a network layer (e.g., IP layer) that is terminated at a packet data network (PDN) gateway on the network side, and an application layer that is terminated at the other end of the connection (e.g., far end UE, server, and/or the like).

The PDCP sublayer 550 provides multiplexing between different radio bearers and logical channels. The PDCP sublayer 550 also provides header compression for upper layer data packets to reduce radio transmission overhead, security by ciphering the data packets, and handover support for UEs between eNBs. The RLC sublayer 540 provides segmentation and reassembly of upper layer data packets, retransmission of lost data packets, and reordering of data packets to compensate for out-of-order reception due to hybrid automatic repeat request (HARQ). The MAC sublayer 530 provides multiplexing between logical and transport channels. The MAC sublayer 530 is also responsible for allocating the various radio resources (e.g., resource blocks) in one cell among the UEs. The MAC sublayer 530 is also responsible for HARQ operations.

In the control plane, the radio protocol architecture for the UE and eNB is substantially the same for the physical layer 510 and the L2 layer 520 with the exception that there is no header compression function for the control plane. The control plane also includes a radio resource control (RRC) sublayer 560 in Layer 3 (L3 layer). The RRC sublayer 560 is responsible for obtaining radio resources (e.g., radio bearers) and for configuring the lower layers using RRC signaling between the eNB and the UE.

As indicated above, FIG. 5 is provided as an example. Other examples are possible and may differ from what was described above in connection with FIG. 5.

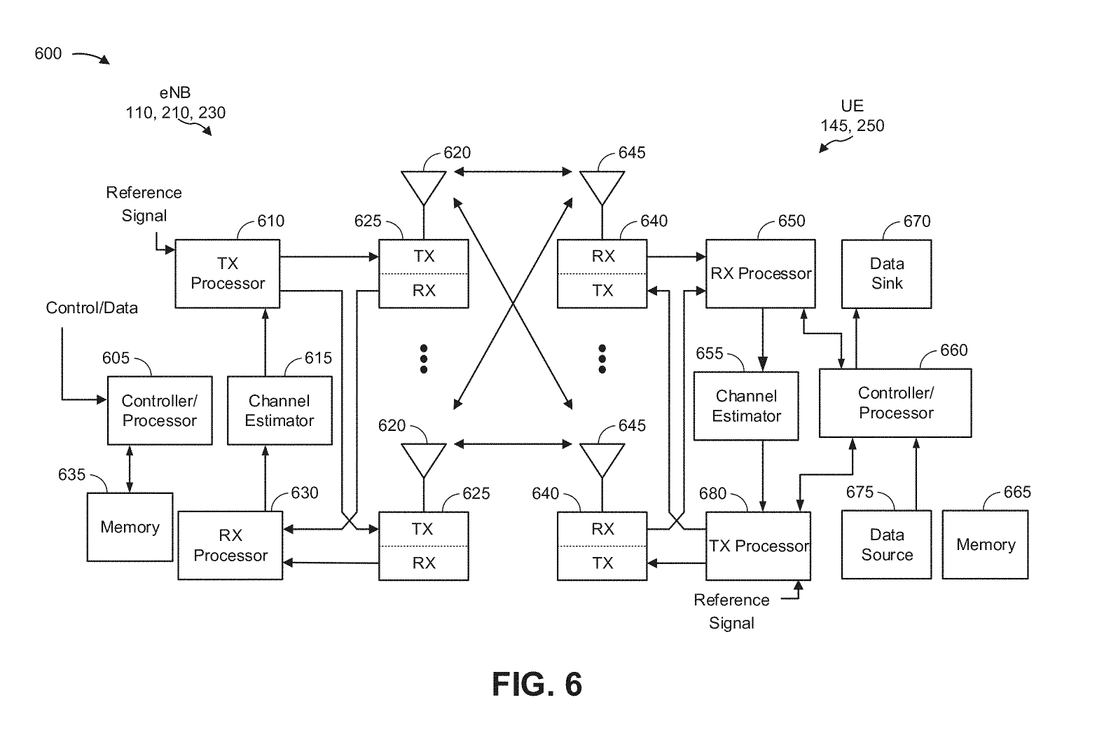

FIG. 6 is a diagram illustrating example components 600 of eNB 110, 210, 230 and UE 145, 250 in an access network, in accordance with various aspects of the present disclosure. As shown in FIG. 6, eNB 110, 210, 230 may include a controller/processor 605, a transmitter (TX) processor 610, a channel estimator 615, an antenna 620, a transmitter 625TX, a receiver 625RX, a receiver (RX) processor 630, and a memory 635. As further shown in FIG. 6, UE 145, 250 may include a receiver RX 640RX, for example, of a transceiver TX/RX 640, a transmitter TX 640TX, for example, of a transceiver TX/RX 640, an antenna 645, an RX processor 650, a channel estimator 655, a controller/processor 660, a memory 665, a data sink 670, a data source 675, and a TX processor 680.

In the DL, upper layer packets from the core network are provided to controller/processor 605. The controller/processor 605 implements the functionality of the L2 layer. In the DL, the controller/processor 605 provides header compression, ciphering, packet segmentation and reordering, multiplexing between logical and transport channels, and radio resource allocations to the UE 145, 250 based, at least in part, on various priority metrics. The controller/processor 605 is also responsible for HARQ operations, retransmission of lost packets, and signaling to the UE 145, 250.

The TX processor 610 implements various signal processing functions for the L1 layer (e.g., physical layer). The signal processing functions includes coding and interleaving to facilitate forward error correction (FEC) at the UE 145, 250 and mapping to signal constellations based, at least in part, on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 615 may be used to determine the coding and modulation scheme, as well as for spatial processing. The channel estimate may be derived from a reference signal and/or channel condition feedback transmitted by the UE 145, 250. Each spatial stream is then provided to a different antenna 620 via a separate transmitter TX 625TX, for example, of transceiver TX/RX 625. Each such transmitter TX 625TX modulates an RF carrier with a respective spatial stream for transmission.

At the UE 145, 250, each receiver RX 640RX, for example, of a transceiver TX/RX 640 receives a signal through its respective antenna 645. Each such receiver RX 640RX recovers information modulated on an RF carrier and provides the information to the receiver (RX) processor 650. The RX processor 650 implements various signal processing functions of the L1 layer. The RX processor 650 performs spatial processing on the information to recover any spatial streams destined for the UE 145, 250. If multiple spatial streams are destined for the UE 145, 250, the spatial streams may be combined by the RX processor 650 into a single OFDM symbol stream. The RX processor 650 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 110, 210, 230. These soft decisions may be based, at least in part, on channel estimates computed by the channel estimator 655. The soft decisions are then decoded and deinterleaved to recover the data and control signals that were originally transmitted by the eNB 110, 210, 230 on the physical channel. The data and control signals are then provided to the controller/processor 660.

The controller/processor 660 implements the L2 layer. The controller/processor 660 can be associated with a memory 665 that stores program codes and data. The memory 665 may include a non-transitory computer-readable medium. In the UL, the controller/processor 660 provides demultiplexing between transport and logical channels, packet reassembly, deciphering, header decompression, control signal processing to recover upper layer packets from the core network. The upper layer packets are then provided to a data sink 670, which represents all the protocol layers above the L2 layer. Various control signals may also be provided to the data sink 670 for L3 processing. The controller/processor 660 is also responsible for error detection using a positive acknowledgement (ACK) and/or negative acknowledgement (NACK) protocol to support HARQ operations.

In the UL, a data source 675 is used to provide upper layer packets to the controller/processor 660. The data source 675 represents all protocol layers above the L2 layer. Similar to the functionality described in connection with the DL transmission by the eNB 110, 210, 230, the controller/processor 660 implements the L2 layer for the user plane and the control plane by providing header compression, ciphering, packet segmentation and reordering, and multiplexing between logical and transport channels based, at least in part, on radio resource allocations by the eNB 110, 210, 230. The controller/processor 660 is also responsible for HARQ operations, retransmission of lost packets, and signaling to the eNB 110, 210, 230.

Channel estimates derived by a channel estimator 655 from a reference signal or feedback transmitted by the eNB 110, 210, 230 may be used by the TX processor 680 to select the appropriate coding and modulation schemes, and to facilitate spatial processing. The spatial streams generated by the TX processor 680 are provided to different antenna 645 via separate transmitters TX, for example, of transceivers TX/RX 640. Each transmitter TX 640TX, for example, of transceiver TX/RX 640 modulates a radio frequency (RF) carrier with a respective spatial stream for transmission.

The UL transmission is processed at the eNB 110, 210, 230 in a manner similar to that described in connection with the receiver function at the UE 145, 250. Each receiver RX 640RX, for example, of transceiver TX/RX 625 receives a signal through its respective antenna 620. Each receiver RX 640RX, for example, of transceiver TX/RX 625 recovers information modulated onto an RF carrier and provides the information to a RX processor 630. The RX processor 630 may implement the L1 layer.

The controller/processor 605 implements the L2 layer. The controller/processor 605 can be associated with a memory 635 that stores program code and data. The memory 635 may be referred to as a computer-readable medium. In the UL, the controller/processor 605 provides demultiplexing between transport and logical channels, packet reassembly, deciphering, header decompression, control signal processing to recover upper layer packets from the UE 145, 250. Upper layer packets from the controller/processor 605 may be provided to the core network. The controller/processor 605 is also responsible for error detection using an ACK and/or NACK protocol to support HARQ operations.

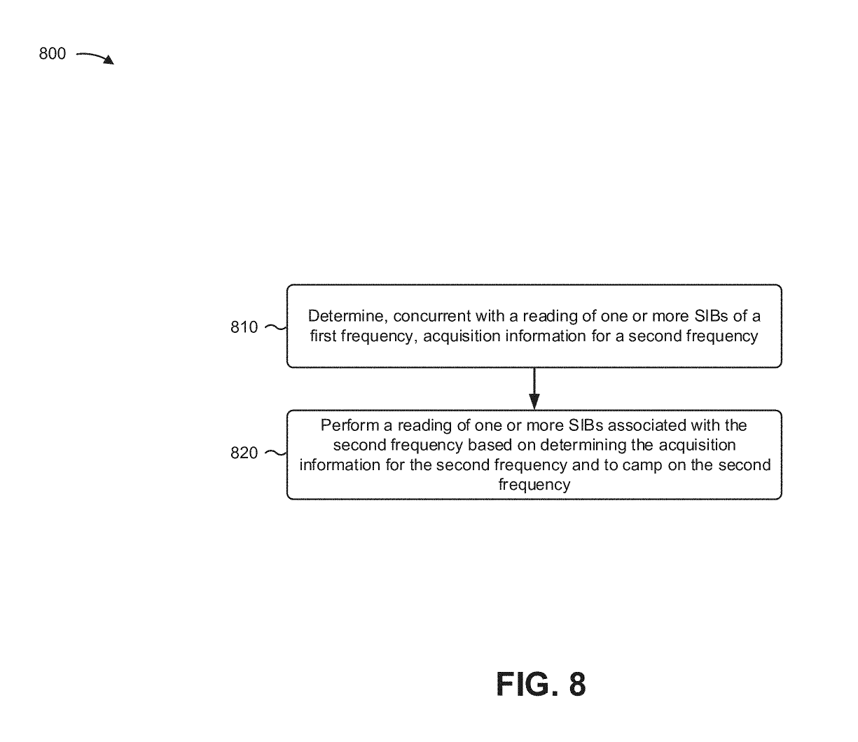

One or more components of UE 145, 250 may be configured to determine, concurrent with a reading of one or more SIBs of a first frequency, acquisition information for a second frequency, as described in more detail elsewhere herein. For example, the controller/processor 660 and/or other processors and modules of UE 145, 250 may perform or direct operations of, for example, process 800 of FIG. 8 and/or other processes, as described herein. In some aspects, one or more of the components shown in FIG. 6 may be employed to perform process 800 of FIG. 8 and/or other processes for the techniques described herein.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of components (e.g., one or more components) shown in FIG. 6 may perform one or more functions described as being performed by another set of components shown in FIG. 6.

As described in more detail below, a wireless communication device, which may correspond to UE 145, 250, may determine, concurrent with a reading of one or more SIBs of a first frequency, acquisition information, such as a set of synchronization codes, for one or more second frequencies, and may perform a reading of one or more SIBs associated with a second frequency, of the one or more second frequencies, to cause the wireless communication device to camp on a cell associated with the second frequency. In this way, UE 145, 250 may reduce an amount of time that elapses for UE 145, 250 to camp on a network after failing to camp on the network using the first frequency relative to determining the acquisition information after failing to camp on the network using the first frequency.

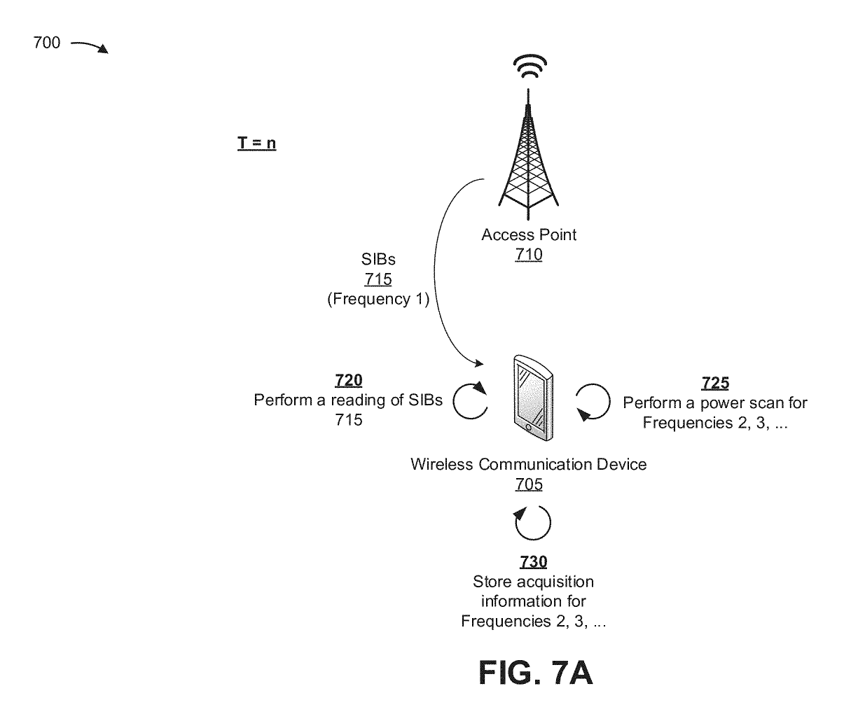

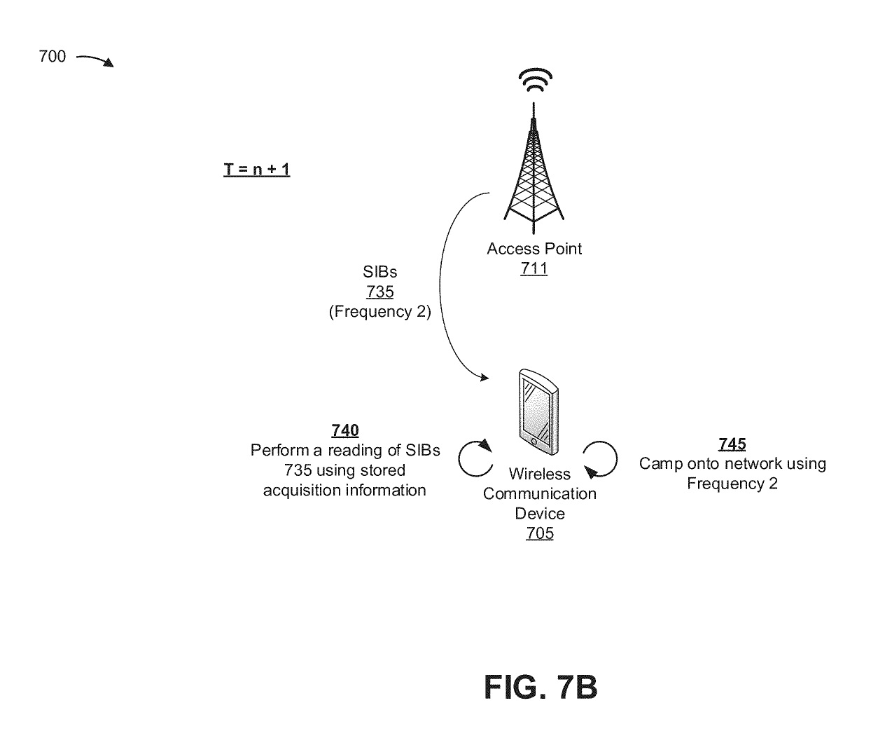

FIGS. 7A and 7B are diagrams illustrating an example 700 of determining, concurrent with a reading of one or more SIBs of a first frequency, acquisition information for a second frequency, in accordance with various aspects of the present disclosure.

As shown in FIG. 7A, example 700 may include a wireless communication device 705 (e.g., a UE, such as UE 145, 250) and an access point 710 (e.g., an eNB, such as eNB 110, 210, 230). Wireless communication device 705 may, at a first time (e.g., T=n), receive SIBs 715 associated with a first frequency (e.g., Frequency 1) from access point 710 (e.g., associated with such frequency). For example, wireless communication device 705 may perform a first power scan of and/or an acquisition procedure for the first frequency to obtain acquisition information regarding the first frequency, such as a set of synchronization codes, and may utilize the acquisition information to obtain and perform a reading of SIBs 715. In some aspects, SIBs 715 may include information associated with indicating whether wireless communication device 705 is permitted to camp on a network using the first frequency.

As further shown in FIG. 7A, and by reference numbers 720 and 725, wireless communication device 705 may perform a reading of SIBs 715 and, concurrently, may perform a power scan of a set of one or more frequencies (e.g., a second frequency, Frequency 2; a third frequency, Frequency 3; and/or the like). For example, wireless communication device 705 may receive and process SIBs 715 based on a transmission schedule of access point 710 and may, during a period of SIB reading when wireless communication device 705 is not receiving SIBs 715, perform a power scan and/or acquisition procedure for such a set of one or more frequencies. In this case, wireless communication device 705 may attempt to camp on a cell associated with the first frequency using SIBs 715 and/or may determine whether the first frequency is a suitable UARFCN on which to camp using SIBs 715. Additionally, wireless communication device 705 may obtain acquisition information regarding the set of one or more frequencies (e.g., a second frequency, Frequency 2; a third frequency, Frequency 3; and/or the like), such as a set of synchronization codes for the set of second frequencies. As shown by reference number 730, wireless communication device 705 may store the acquisition information regarding the set of second frequencies, such as via a data structure of wireless communication device 705.

As shown in FIG. 7B, wireless communication device 705 may, at a second time (e.g., T=n+1), receive SIBs 735 associated with the second frequency from an access point 711 (e.g., another access point or the same access point). For example, based on failing to camp on the first frequency (e.g., as a result of SIBs 715 indicating that the UARFCN associated with the first frequency is barred), wireless communication device 705 may utilize the stored acquisition information regarding the second frequency to obtain and read SIBs 735. As shown by reference number 740, wireless communication device 705 may perform a reading of SIBs 735 using the stored acquisition information. For example, wireless communication device 705 may determine, based on SIBs 735, that an access point 711 associated with the second frequency is suitable to camp on the network. As shown by reference number 745, wireless communication device 705 may camp on the network based on performing the reading of SIBs 735.

In this way, UE 145, 250, 705 reduces an amount of time to camp on the network, when camping on the network via the first frequency fails, relative to performing a power scan to obtain acquisition information for a second frequency after determining that camping on the network via the first frequency fails.

In the event that camping on the network via the second frequency also fails, UE 145, 250, 705 may repeat the above operations to attempt to camp on the network via a third frequency, and so on. In any event, UE 145, 250, 705 reduces an amount of time used to camp on the network by not waiting for the camping operation to fail on one frequency before obtaining acquisition information for another frequency.

As indicated above, FIGS. 7A and 7B are provided as an example. Other examples are possible and may differ from what was described with respect to FIGS. 7A and 7B.

FIG. 8 is a diagram illustrating an example process 800 performed, for example, by a wireless communication device (e.g., a UE 145, 250, 705), in accordance with various aspects of the present disclosure. Example process 800 is an example where a wireless communication device determines, concurrent with a reading of one or more SIBs of a first frequency, acquisition information for a second frequency.

As shown in FIG. 8, in some aspects, process 800 may include determining, concurrent with a reading of one or more SIBs of a first frequency, acquisition information for a second frequency (block 810). For example, the wireless communication device may determine acquisition information for the second frequency during a reading of the one or more SIBs of the first frequency. The acquisition information may include a set of synchronization codes, such as a set of primary synchronization signals and/or secondary synchronization signals, or a cell identifier, associated with the second frequency and/or the like.

In some aspects, the wireless communication device may perform a power scan of and/or an acquisition procedure for a set of one or more frequencies to obtain the acquisition information for the second frequency. For example, concurrent with the reading of the one or more SIBs, the wireless communication device may perform a power scan of the set of one or more frequencies to identify a cell associated with the second frequency (e.g., before completion of the reading of the one or more SIBs of the first frequency), and may store acquisition information regarding the UARFCN of the second frequency in a data structure. In this case, the wireless communication device may store acquisition information relating to the second frequency for utilization after a failure to camp on the cell associated with the first frequency or at another subsequent time. In this way, the wireless communication device reduces an amount of time to camp on the cell associated with the second frequency relative to obtaining the acquisition information for the second frequency after failing to camp on the cell associated with the first frequency and determining to attempt to find a suitable cell to camp on.

In some aspects, the wireless communication device may perform the power scan during a period of time that the wireless communication device is waiting to receive a particular SIB of the first frequency (e.g., concurrent with a reading of the particular SIB). For example, after determining to perform a SIB reading for the first frequency, the wireless communication device may determine a period of time when the wireless communication device is to receive a SIB of the first frequency (e.g., based on a SIB transmission schedule of the network, for example, provided in a master information block (MIB)), and may perform the power scan during one or more periods of time for which the wireless communication device is not receiving a SIB associated with the first frequency. In this way, the wireless communication device obtains acquisition information for the second frequency without interrupting a SIB reading for the first frequency. Moreover, the wireless communication device reduces an amount of time to camp on a cell associated with the second frequency relative to becoming idle during the one or more periods of time for which the wireless communication device is not receiving a SIB of the first frequency and subsequently obtaining the acquisition information for the second frequency after failing to camp on the cell associated with first frequency.

In some aspects, the wireless communication device may attempt to camp on the cell associated with the first frequency based on reading the one or more SIBs associated with the first frequency. For example, the wireless communication device may exchange one or more signaling messages with an access point to camp on the first frequency, and may fail to camp on the first frequency, such as based on a cell suitability check (e.g., based on a signal strength for the first frequency failing to satisfy a threshold signal strength). Additionally, or alternatively, the wireless communication device may fail to camp on the first frequency based on reading the one or more SIBs associated with the first frequency. For example, the wireless communication device may determine, based on reading the one or more SIBs associated with the first frequency, that the first frequency is barred or unavailable, such as based on a quantity of other wireless communication devices using the first frequency. Additionally, or alternatively, the wireless communication device may determine that the SIB read failed for the one or more SIBs associated with the first frequency (e.g., as a result of one or more lost packets). In this case, the wireless communication device may determine to perform a reading of one or more SIBs associated with the second frequency to attempt to camp on the second frequency.

As shown in FIG. 8, in some aspects, process 800 may include performing a reading of one or more SIBs associated with the second frequency based on determining the acquisition information for the second frequency and to camp on the second frequency (block 820). For example, the wireless communication device may perform the reading of the one or more SIBs associated with the second frequency based on determining the acquisition information for the second frequency and to camp on the second frequency. In some aspects, the wireless communication device may determine, concurrent with the reading of the one or more SIBs associated with the second frequency, acquisition information regarding a third frequency.

In some aspects, the wireless communication device may obtain the acquisition information from a data structure. For example, after storing acquisition information determined concurrent with a first reading of a first one or more SIBs of a first frequency, the wireless communication device may obtain the stored acquisition information, and may utilize the stored acquisition information to perform a reading of a one or more SIBs associated with the second frequency.

In some aspects, the wireless communication device may camp on the second frequency based on performing the reading of the one or more SIBs associated with the second frequency. For example, based on determining that the second frequency is not barred using information included in the one or more SIBs associated with the second frequency, the wireless communication device may exchange one or more signaling messages with an access point to camp on a network (e.g., a cell thereof) using the second frequency. In this way, the wireless communication device may provide network connectivity in a reduced amount of time relative to obtaining the acquisition information for the second frequency after failing to camp on the first frequency.

In some aspects, subsequent to performing the reading of the one or more SIBs associated with the second frequency (e.g., subsequent to camping on the second frequency), the wireless communication device may enter an out of service (OOS) state. For example, the wireless communication device may enter the OOS state after camping on the second frequency, and may determine to transfer from the OOS state to return to camping on the network. In this case, the wireless communication device may check a validity of a database storing acquisition information (e.g., acquisition information relating to the first frequency, the second frequency, a third frequency, and/or the like), and may utilize the acquisition information to perform one or more SIB readings (e.g., of the first frequency, of the second frequency, of the third frequency, and/or the like). Based on determining that the database is valid, the wireless communication device may attempt to read one or more SIBs associated with one or more frequencies of the database and may, concurrently, update the database based on obtaining updated acquisition information during SIB reading. In this way, by storing the acquisition information via the data structure, the wireless communication device may reduce an amount of time to camp on a network from an OOS state relative to obtaining new acquisition information for each attempt to camp on the network.

Additionally, or alternatively, process 800 may include camping on a cell associated with the second frequency based on performing the reading of the one or more SIBs associated with the second frequency.

Additionally, or alternatively, process 800 may include performing at least one of a power scan or acquisition of the second frequency.

Additionally, or alternatively, process 800 may include performing an attempt to camp on a cell associated with the first frequency, determining that the attempt to camp on the first frequency failed, and performing the reading of the one or more SIBs associated with the second frequency based on determining that the attempt to camp on the cell associated with first frequency failed.

Additionally, or alternatively, process 800 may include determining that a frequency channel associated with the first frequency is unavailable.

Additionally, or alternatively, process 800 may include storing the acquisition information for the second frequency in a data structure.

Additionally, or alternatively, process 800 may include obtaining the acquisition information for the second frequency from the data structure and performing the reading of the one or more SIBs associated with the second frequency based on the obtained acquisition information.

Additionally, or alternatively, process 800 may include entering an out of service state after performing the reading of the one or more SIBs associated with the second frequency, validating the acquisition information stored in the data structure after entering the out of service state, obtaining acquisition information for a third frequency from the data structure, and performing a reading of one or more SIBs associated with the third frequency and to cause the wireless communication device to camp on the third frequency.

Additionally, or alternatively, the acquisition information may include a set of one or more synchronization codes for the second frequency.

Additionally, or alternatively, process 800 may include determining acquisition information for the second frequency before completion of the reading of one or more SIBs of the first frequency.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

Techniques and apparatuses described herein may cause a wireless communication device to determine, concurrent with a reading of one or more SIBs of a first frequency, acquisition information for a second frequency. This may improve a performance of the wireless communication device by reducing a power utilization of the wireless communication device and/or a utilization of network resources by the wireless communication device, and may reduce an amount of time used by the wireless communication device to camp on a network.

The foregoing disclosure provides illustration and description, but is not intended to be exhaustive or to limit the aspects to the precise form disclosed. Modifications and variations are possible in light of the above disclosure or may be acquired from practice of the aspects.

As used herein, the term component is intended to be broadly construed as hardware, firmware, or a combination of hardware and software. As used herein, a processor is implemented in hardware, firmware, or a combination of hardware and software.

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, and/or the like.

It will be apparent that systems and/or methods, described herein, may be implemented in different forms of hardware, firmware, or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of possible aspects. In fact, many of these features may be combined in ways not specifically recited in the claims and/or disclosed in the specification. Although each dependent claim listed below may directly depend on only one claim, the disclosure of possible aspects includes each dependent claim in combination with every other claim in the claim set. A phrase referring to “at least one of” a list of items refers to any combination of those items, including single members. For example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the term “one” or similar language is used. Also, as used herein, the terms “has,” “have,” “having,” and/or the like are intended to be open-ended terms. Further, the phrase “based on” is intended to mean, “based, at least in part, on” unless explicitly stated otherwise.

What is claimed is:

1. A method for wireless communication, comprising:
determining, by a wireless communication device and concurrent with a reading of one or more system information blocks (SIBs) of a first frequency, acquisition information for a second frequency; and
performing, by the wireless communication device, a reading of one or more SIBs associated with the second frequency based on determining the acquisition information for the second frequency and to cause the wireless communication device to camp on a cell associated with the second frequency.

2. The method of claim 1, further comprising:
camping on the cell associated with the second frequency based on performing the reading of the one or more SIBs associated with the second frequency.

3. The method of claim 1, wherein determining the acquisition information for the second frequency includes:
performing at least one of a power scan or an acquisition of the second frequency.

4. The method of claim 1, further comprising:
performing an attempt to camp on a cell associated with the first frequency;
determining that the attempt to camp on the cell associated with the first frequency failed; and
wherein performing the reading of the one or more SIBs associated with the second frequency includes:
performing the reading of the one or more SIBs associated with the second frequency based on determining that the attempt to camp on the cell associated with the first frequency failed.

5. The method of claim 4, wherein the attempt to camp on the cell associated with the first frequency includes at least one of an acquisition attempt or a cell suitability check.

6. The method of claim 4, wherein determining that the attempt to camp on the first frequency failed includes:
determining that a frequency channel associated with the first frequency is unavailable.

7. The method of claim 1, further comprising:
storing the acquisition information for the second frequency in a data structure.

8. The method of claim 7, wherein performing the reading of the one or more SIBs associated with the second frequency includes:
obtaining the acquisition information for the second frequency from the data structure; and
performing the reading of the one or more SIBs associated with the second frequency based on the obtained acquisition information.

9. The method of claim 7, further comprising:
entering an out of service state after performing the reading of the one or more SIBs associated with the second frequency;
validating the acquisition information stored in the data structure after entering the out of service state;
obtaining acquisition information for a third frequency from the data structure; and
performing a reading of one or more SIBs associated with the third frequency and to cause the wireless communication device to camp on a cell associated with the third frequency.

10. The method of claim 1, wherein the acquisition information comprises a set of one or more synchronization codes for the second frequency.

11. The method of claim 1, wherein determining acquisition information for the second frequency includes determining acquisition information for the second frequency before completion of the reading of one or more SIBs of the first frequency.

12. A non-transitory computer-readable medium storing one or more instructions for wireless communication, the one or more instructions comprising:
one or more instructions that, when executed by one or more processors of a wireless communication device, cause the one or more processors to:
determine, concurrent with a reading of one or more system information blocks (SIBs) of a first frequency, acquisition information for a second frequency; and
perform a reading of one or more SIBs associated with the second frequency based on determining the acquisition information for the second frequency and to cause the wireless communication device to camp on a cell associated with the second frequency.

13. The non-transitory computer-readable medium of claim 12, wherein the one or more instructions, when executed by the one or more processors, further cause the one or more processors to:
camp on the cell associated with the second frequency based on performing the reading of the one or more SIBs associated with the second frequency.

14. The non-transitory computer-readable medium of claim 12, wherein the one or more instructions, that cause the one or more processors to determine the acquisition information for the second frequency, cause the one or more processors to:
perform at least one of a power scan or an acquisition of the second frequency.

15. The non-transitory computer-readable medium of claim 12, wherein the one or more instructions, when executed by the one or more processors, further cause the one or more processors to:
perform an attempt to camp on a cell associated with the first frequency;
determine that the attempt to camp on the cell associated with the first frequency failed; and
wherein the one or more instructions, that cause the one or more processors to perform the reading of the one or more SIBs associated with the second frequency, further cause the one or more processors to:
perform the reading of the one or more SIBs associated with the second frequency based on determining that the attempt to camp on the cell associated with the first frequency failed.

16. The non-transitory computer-readable medium of claim 15, wherein the one or more instructions, that cause the one or more processors to determine that the attempt to camp on the cell associated with the first frequency failed, further cause the one or more processors to:
determine that a frequency channel associated with the first frequency is unavailable.

17. An apparatus for wireless communication, comprising:
means for determining, concurrent with a reading of one or more system information blocks (SIBs) of a first frequency, acquisition information for a second frequency; and
means for performing a reading of one or more SIBs associated with the second frequency based on determining the acquisition information for the second frequency and to cause the wireless communication device to camp on a cell associated with the second frequency.

18. The apparatus of claim 17, further comprising:
means for camping on the cell associated with second frequency based on performing the reading of the one or more SIBs associated with the second frequency.

19. The apparatus of claim 17, wherein the means for determining the acquisition information for the second frequency includes:
means for performing at least one of a power scan or an acquisition of the second frequency.

20. The apparatus of claim 17, further comprising:
means for performing an attempt to camp on a cell associated with the first frequency;
means for determining that the attempt to camp on the cell associated with the first frequency failed; and
wherein the means for performing the reading of the one or more SIBs associated with the second frequency includes:
means for performing the reading of the one or more SIBs associated with the second frequency based on determining that the attempt to camp on the cell associated with the first frequency failed.
